(19) United States
(12) Patent Application Publication
(10) Pub. No.: US 2003/0014747 A1
(43) Pub. Date: Jan. 16, 2003

(54) Method and device for suppressing unwanted program parts for entertainment electronics devices

(76) Inventor: Clemente Spehr, Munchen (DE)

Correspondence Address: Frank Chau, F Chau & Associates, 1900 Hempstead Turnpike, Suite 501, East Meadow, NY, 11554, US

(21) Appl. No.: 09/980,423

(22) PCT Filed: Dec. 14, 2000
(86) PCT No.: PCT/EP00/04827

(30) Foreign Application Priority Data
Jun. 2, 1999 (DE) 199 25 387.0

(51) Int. Cl. H04N 7/16; H04H 9/00; H04N 7/10; H04N 7/025

(52) U.S. Cl. 725/22; 725/32; 348/907

(57) ABSTRACT

What are proposed are a method and an apparatus for suppressing advertising for apparatuses appertaining to consumer electronics, in particular for radio, television and video apparatuses. The undesirable program sections are defined in accordance with a coded identification signal which can be received in this regard from an online service provider, in particular an Internet service provider. An undesirable program section is then automatically identified as such on the basis of particular specific features and a corresponding identification signal is supplied, in response to which the suppression takes place.

### PRIOR ART

The present invention relates to a method and apparatuses for suppressing undesirable program sections, in particular advertising, for apparatuses appertaining to consumer electronics, in particular the suppression of the reproduction of transmitted advertising blocks on connected television and/or radio receivers, and also the suppression of their recording on connected recording devices, such as e.g. video recorders or audio tape apparatuses.

Although applicable in principle to advertising in any desired transmitting/receiving systems, the present invention and also the problem area on which it is based are explained in more detail with regard to a stationarily connected television set.

The transmission of advertising blocks as an interruption to a transmission, such as e.g. an exciting feature film, meets with disapproval from many television viewers. The viewers are forced to follow the advertising at least with reduced attention if they do not wish to miss the return to the transmission after the end of the advertising block.

Since, at the beginning of the advertising block, the television set cannot automatically be turned off or have its volume turned down, and does not automatically switch to a different program or switch to some other operating mode that may be desired, said viewers are compelled themselves to take measures like those outlined above at the beginning of an advertising block if they are not interested in advertising.

This requires a degree of discipline, however. If it is not applied, then said viewers accept their “fate” and, by following the advertising in an undesirable manner, are actually confronted with the contents of the advertising against their will and, as it were, “torn away” from the transmission that was previously being followed.

It has proved to be particularly disadvantageous that the return to the transmission after the end of the advertising block is often missed if, during the advertising block, the viewers themselves turn down the volume of the apparatus or switch it to a different transmitter in order to bridge the advertising time.

The problem area on which the present invention is based thus generally consists in making the viewers more independent of the temporally designed program scheme in a manner that is convenient for them, in particular in assisting such viewers to the effect that they themselves no longer have to take care of the suppression of the advertising block and the exit from the respective advertising block and the return to the transmission of interest take place automatically.

A further object of the invention consists in creating, for the viewer, a degree of interactivity and flexibility in receiving television transmissions, and also in enabling feedback messages to a service provider which is active in the field of the “television market” according to the present invention.

### ADVANTAGES OF THE INVENTION

The method according to the invention having the features of claim 1 in connection with the apparatus according to the invention according to claim 7 have the particular advantage that the viewers, without their assistance, are freed of the tiresome necessity of watching the advertising blocks and—if desired—impressions are not diverted by undesirable advertising commercials.

The idea on which the present invention is based consists in the presence and the absence of an advertising block being identified automatically by the evaluation of predetermined criteria, to be precise preferably with statistical assessment of the individual criteria. From this an advertising-block-is-running signal and a complimentary advertising-block-is-not-running signal are obtained for the broadcasting corporations analyzed and made available to the receiver, i.e. the television viewer or radio listener, by a control box.

As a result, it is possible, during the transmission time of the advertising block, for the television set or radio set to be switched to a different operating mode, for example for the volume to be reduced, or to be switched to a different transmitter, etc., and, after the end of the advertising block, to be switched back again to the same operating mode which was present before the start of the advertising block. In the simplest case, the advertising-block-is-running signal and the complimentary advertising-block-is-not-running signal are a simple multibit signal, a broadcasting corporation corresponding to each bit.

The subclaims contain advantageous developments and improvements of the method specified in claim 1 and, respectively, of the control box specified in claim 7.

In accordance with a particularly preferred development, a database system set up at a central service provider is utilized for identifying the advertising blocks and a multiplicity of predetermined criteria are used for distinguishing between advertising and non-advertising. The criteria are weighted individually in order to influence an overall result of the evaluation.

In accordance with a further preferred development, the control box is set up with an interface to an online service in order to interrogate the evaluation result of the service provider. This affords the advantage that the signal—to be transmitted by the service provider—for discrimination between advertising and non-advertising can be transmitted not necessarily via the air but also in a cable-based manner.

A further aspect of the present invention proposes that the control box is set up for transmitting particular information which describes the viewers' television consumption to a service provider for the purpose of evaluation. The information is intended to make it clear to the service provider when what program was received and for how long. The data can be transmitted to the service provider via the Internet, for example, or equally as a digital short message (SMS) using a mobile phone, which, in accordance with a further preferred exemplary embodiment of the control box, provides a connection for such a mobile phone. This information requires only a few bits.

In accordance with a further aspect of the present invention, the control box is able to receive a “replacement program” for masked-out program sections. In connection with the previously mentioned aspect, this affords the advantage that certain main points of interest or preferences of a viewer can be expressed when selecting a replacement for undesirable program sections, such as advertising or violence, for example. On the part of the service provider, every transmitted television transmission as well as every transmitted advertising block or advertising commercial can preferably be provided with a particular coding which allows the orientation of the contents of the transmission or of the advertising commercial to be coded. This then results solely from the data transmitted to the service provider by the viewer, since said data represent said viewer's preferences. In this way, it is possible for particular interest groups such as, for example, families, housewives, the self-employed, so-called high earners, sportsmen and -women, etc., to be selectively supplied with those contents which it can be assumed meet with heightened interest in the case of one of the groups of people mentioned.

In accordance with a further preferred exemplary embodiment of the present invention, the receiving device of the control box may also be able to be connected to an Internet connection, so that it is possible to surf the Internet during a television commercial break.

In accordance with a further aspect of the present invention, the control box is provided with a buffer as a temporary memory for sound and/or picture information with regard to particular sections, i.e. excerpts from the currently received transmission. With this buffer memory, not only can the current program be shown in a temporally staggered manner if the current program is fed into the buffer memory as required, and can then be freely retrieved, but it is additionally possible to exhaust the complete length of particular alternative transmissions which are shown instead of an advertising block in the original film, without having to consider the recommencement of the original film after the commercial break. In this way, the viewer becomes significantly more independent of the schedule of the television transmitter. The viewer will no longer miss the restart of the film.

In accordance with a further aspect of the present invention, the buffer memory can also be used for loading particular data, film sequences or video sequences from a data reservoir with a low transfer rate, such as the Internet, for instance, as a result of which it is possible to view them only when they are present in their entirety in the buffer memory. As a result, a replacement program can be made available by the service provider in a simple manner and the advantage is afforded that the data reproduction speed is independent of the data loading speed.

In accordance with a further aspect of the present invention, an input device for defining undesirable program sections is provided. In other words, the user can stipulate which program sections are to be masked out by a replacement program. Thus, if said user defines scenes of violence as undesirable in order to protect minors, then said scenes can always be masked out—provided that the service provider transmits the identification signal reliably.

### DRAWINGS

Exemplary embodiments of the invention are illustrated in the drawings and are explained in more detail in the description below.

In the figures:

FIG. 1 shows a diagrammatic illustration of essential sequences of the method according to the invention which are required in the identification of the advertising block by a service provider;

FIG. 2 shows a more precise diagrammatic illustration of the identification of the advertising block;

FIG. 3 shows a diagrammatic illustration of details in the evaluation of the information sequences stored in the database system;

FIG. 4 shows a diagrammatic illustration of the mode of operation of the control box according to the invention in the context of the method according to the invention;

FIG. 5 shows a more precise diagrammatic illustration of the mode of operation of the control box according to the invention in the context of the method according to the invention;

FIG. 6 shows a diagrammatic illustration of essential sequences of the method according to the invention which are required in the identification of the advertising block by a service provider, with a preferred supplementation which enables the learning of features; and

FIG. 7 shows a diagrammatic illustration of a block diagram of the control box in a further preferred embodiment.

### DESCRIPTION OF THE EXEMPLARY EMBODIMENTS

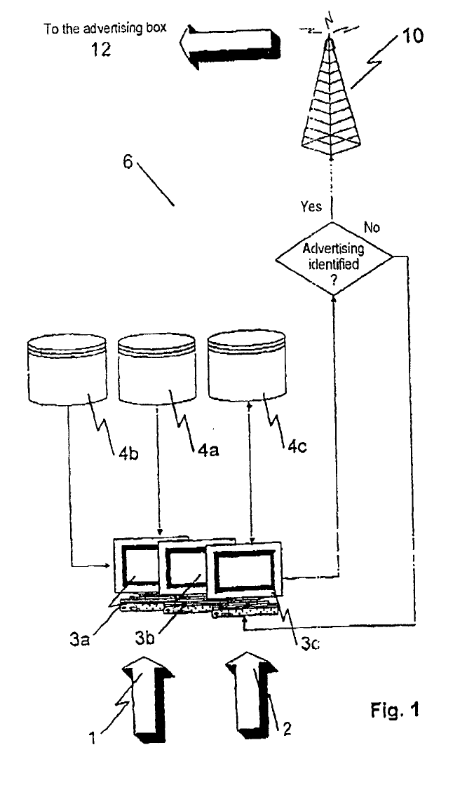

FIG. 1 shows a diagrammatic illustration of essential sequences of the method according to the invention which are required in the identification of an advertising block by a service provider.

In FIG. 1, the reference symbol 1 designates sound signals of a plurality of television transmitters, the reference symbol 2 designates the associated picture signals of the transmitters, the reference symbols 3a to 3c designate evaluation stations of the signals for each of the transmitters, the reference symbol 4a designates a database for cross-transmitter features, the reference symbol 4b designates a database for transmitter-specific features, the reference symbol 4c designates a database for film repetition features, and the reference symbol 6 designates the evaluation system essentially formed by the databases and the evaluation stations.

A service provider concerned with the identification of the advertising blocks during the transmission time of a multiplicity of television transmitters simultaneously receives all those transmitters for which it offers its service of “generation and transmission of the advertising-block-is-running and advertising-block-is-not-running signal” to viewers interested in suppressing advertising blocks.

The service provider processes the signals of the transmitters, for the purpose mentioned above, expediently separately according to sound signal 1 and picture signal 2 in a plurality of logically and physically separate branches; the sound signals in the evaluation station 3a, the picture signals in the evaluation station 3b. The evaluation station 3c combines the results of the stations 3a and 3b, which is described in more detail below.

Advertising commercials which have been identified and, if appropriate, read in separately beforehand and stored or particular parts of said advertising commercials, which, taken together, are referred to below as “features”, are stored as information sequences for the identification of the advertising blocks during current transmission operation in the database system 4a, 4b, 4c.

An information sequence may, in principle, be of any desired length; however, for practical reasons of memory space requirement and computer speed, a range of from about 0.5 to a few seconds is recommended, preferably of the order of magnitude of the longest advertising commercials.

The evaluation system 6, which contains the workstations 3a, 3b, 3c, which may be conventional PCs, and also includes the database system, expediently analyzes the incoming signals of the broadcasting corporations as information sequences by comparison with the particular information sequences—stored in the database system 4— of the information sequences that have already been identified as belonging to advertising commercials.

In this case, the database system 4a, 4b, 4c is divided into three areas which each represent a dedicated database and are specifically explained in more detail below:

Firstly, all those features which are not transmitted exclusively on one transmitter are stored in the database 4a for cross-transmitter features. Examples thereof are e.g. advertising transmitted on a plurality of transmitters.

All branches of the evaluation system have access to this database 4a. If an information sequence is identified as advertising by the evaluation unit of a transmitter, this also leads to evaluation as advertising in all the other evaluation units and hence in all the other transmitters.

Furthermore, the database 4b for transmitter-specific features exists for each transmitter for which the service is offered. Information sequences which are specific to a particular transmitter are stored here. Examples thereof would be the so-called “trailers” of advertising blocks including, for instance, ZDF's “Mainzelmännchen”.

The third database 4c is a memory for so-called repetition features of a transmitted film. If a film is interrupted by an advertising block, then when the film commences again, the last film sequence which was broadcast before the advertising is often repeated again in order to make the viewer aware of the last film scene again for the purpose of remembrance. Otherwise, the film usually resumes with a sequence which is very similar to that immediately prior to the start of the advertising block. The recommencement of the film can be established by comparison with the present information sequence currently being transmitted with that stored last in the memory 4c.

The evaluation system thus constructed initiates the sending or transmission of the advertising-block-is-running or advertising-block-is-not-running signal if it has identified an advertising block in the course of the evaluation proceeding from its starting point after the signals 1, 2 arrived.

The television viewers who wish to take up the service must possess the control box which can communicate with their television set or radio set and is set up for receiving and processing this signal in order to control the television set or radio set in such a way that, during the transmission of the advertising-block-is-running signal, a predetermined other operating mode of the television set, in which no advertising is received, is set.

The no branch 10 involves the case where the evaluation system has not identified an advertising block. In this case, there is a branching back to the starting point again and the sequence described above is repeated. The repetition frequency might be, for example 10 Hz or higher depending on the computer power.

Essential features for the start of the advertising block, which are acquired in database terms, are outlined below.

Subtitles for the hard of hearing: Subtitles are broadcast only for films, but not for advertising. The probability of advertising increases when subtitles end.

Change in the picture format: Advertising is not usually recorded using the Cinemascope method. In the event of a change from film to advertising, the black bars which characterize this method disappear. This method also applies to films broadcast in the modern 16:9 format.

Two-channel sound: The same applies here as to subtitles, since advertising is not normally broadcast in a number of languages.

VPS signal: Films end and begin respectively with the end and the beginning of the VPS signal, and so the beginning and, respectively, the end of advertising is also identified.

Omission of the transmitter logo: The transmitter logo is broadcast only during contents for which the transmitter is responsible, and not during advertising.

Logos of the advertising agency: These logos can be found by picture excerpt identification or by text identification.

The start time of the advertising blocks is defined: The advertising blocks are not broadcast entirely randomly by the broadcasting corporations, but rather in blocks which are usually fixedly defined with respect to time before and after films. Moreover, the beginning of films is announced beforehand in the media. Therefore, the probability of the advertising block occurring rises as the planned start time for said advertising block approaches.

Technical differences in the received picture signal: These may be understood to be possibly cutting signals or else differences in picture quality. Different recording and reproduction apparatuses generate a different background noise or, for example different color temperatures, which can be detected.

Comparison of picture sequences: A very important feature is the comparison of the present information sequence with advertising commercials that have already been identified as advertising and stored in the databases, as has already been explained above. The identification probability is very high and accurate in the case of this feature.

Logos or speech/music: Advertising can also be identified as such by text, speech or music recognition by examining individual pictures and the sound signal. For example, existing logos such as “Lenor”, “Persil” or other known advertising slogans or a typical distinctive music are thus identified.

Legally prescribed advertising trailer: the most important feature for identifying the beginning and end of advertising is the clear marking—prescribed in the media law—of advertising blocks by corresponding identifier sequences, so-called trailers. Under certain circumstances, these trailers alone may suffice to unambiguously identify advertising.

It is somewhat more difficult to identify the end of the advertising block. If this is not noticed, or is noticed belatedly, for instance, then the user's enjoyment of the film is considerably disturbed since said user would miss the return to the actual transmission.

In principle, the same fundamental features as applied to identifying the beginning of the advertising commercials apply to the identification of the end of the advertising block. However, over and above these there are also further indicators which allow the end of advertising to be reliably established:

The running time of the advertising blocks is usually constant, i.e. the probability of an end of the advertising block also increases as the running time of the advertising blocks increases or the number of individual commercials increases. Moreover, the length of advertising blocks does not usually exceed a particular maximum time.

The transmitter logo: When the film restarts, the transmitter logo is also inserted again

Comparison of film sequences: When interrupted film transmissions restart, the preceding sequence is usually repeated again in order to facilitate the return for the viewers. If this is not the case, then the new sequence is usually very similar to the last sequence shown prior to the advertising, and can be identified.

Reference to other transmission or the individual logos or indicators thereof: If the advertising is broadcast at the end of a film, it is usually followed by announcements, weather report or news, whose logos can in turn be identified.

The identification or discrimination of different advertising commercials is important in order additionally to identify an accurate boundary for the end of advertising blocks. In addition to the features for establishing the end and beginning of the advertising block, the following relationship can also furthermore be utilized in order to identify an advertising commercial as such:

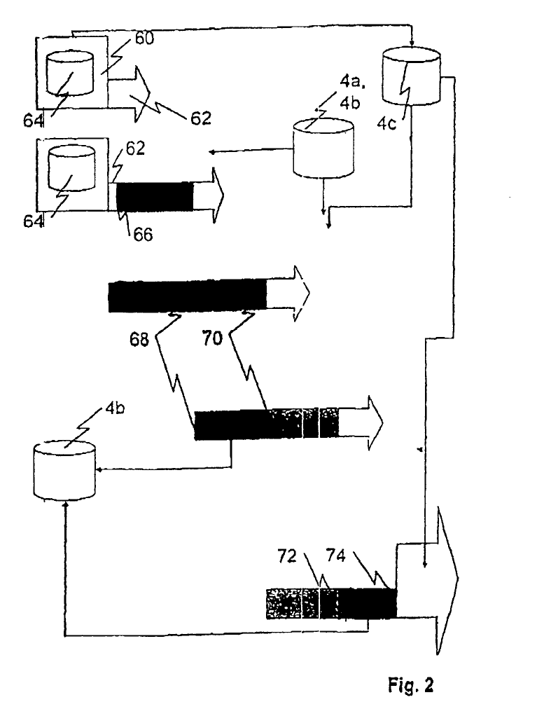

If a new, that is to say hitherto unknown, commercial is situated between two already identified advertising commercials, then this commercial must also be an advertising commercial. Consequently, its beginning and end are defined and the commercial can be correspondingly stored (also see description for FIG. 2).

If an information sequence corresponding to an advertising commercial is identified as advertising on the basis of company logos and is followed by an identified commercial, then the new commercial can be stored in one of the databases.

FIG. 2 shows a more precise diagrammatic illustration of the identification of advertising blocks by the evaluation system 6 of the service provider.

In FIG. 2, reference symbols identical to those in FIG. 1 show the same parts or method sequences; 64 designates a buffer memory.

The figure is to be read essentially line by line from left to right and from top to bottom. The time runs from left to right.

A particular transmitter with a film in the 16:9 wide-screen format is received at reference symbol 60. In this case, at least essential parts of the information contained in the picture and/or in the sound are stored in a buffer memory 64 and in each case overwritten again anew by the respective “fresh” information after a particular clock sequence. At 62, a 16:9 picture format is suddenly no longer present. The last items of picture and/or sound information which still originate from the 16:9 format are stored in the database 4c for film repetition features.

With the next line in the figure, which is to be regarded as a temporal development from the first line, at 62 there begins a comparison of the signal which is no longer present in the 16:9 format with information sequences or features which are present in the databases 4a or 4b. At 66, that is to say a short time after 62, identity between a transmitted and an already stored advertising trailer was discovered. Consequently, the evaluation system transmits the advertising-block-is-running signal.

At 68, through comparison with the features in the databases 4a, 4b, an undefined signal is established, an information sequence which might possibly be a further, new advertising commercial since there is still no 16:9 picture format present as an indication of the recommencement of the film, and the information sequence corresponds to none of the commercials already stored. A comparison with the information sequences stored in the database 4c is effected, during which no correspondence or similarity whatsoever is established. In this case, the undefined information sequence was buffer-stored as a precaution in an area of the memory 64. At 70 in lines three and four of the figure, the beginning of an already known advertising commercial is identified by the evaluation system. The conclusion that the undefined area between 68 and 70 was also an advertising commercial is drawn from this. It is therefore stored as new commercial in the database 4b.

The same new identification takes place in the bottommost line of the figure between 72 and 74 for identifying a new trailer after the end of the known advertising commercial and before the recommencement of the film in the 16:9 picture format. Therefore, the new trailer is also stored in the database 4b once the recommencement of the film and hence the end of the advertising block have also been identified entirely satisfactorily by comparison of the present information sequence in the 16:9 format with the information stored in the database 4c for film repetition features.

In this way, advertising blocks can also be identified under more difficult conditions (occurrence of a new advertising commercial) and the obtained information of the new advertising block can be utilized for the purpose of a later use for further comparisons as above, in which case, however, the identification of the same, at that time new, advertising commercial can be effected rapidly.

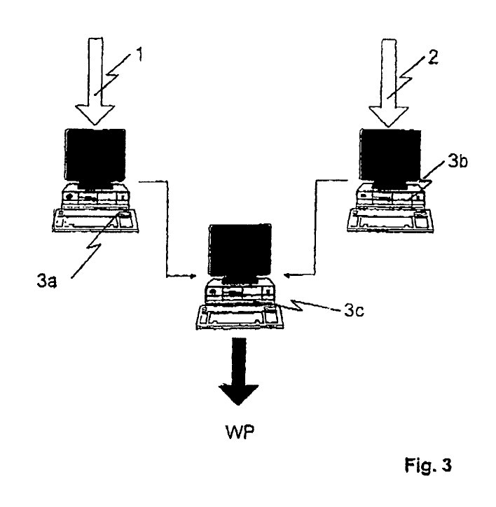

FIG. 3 shows a diagrammatic illustration of a detail in the evaluation of the information sequences stored in the database system.

In FIG. 3, reference symbols identical to those in FIG. 1 designate the same parts and 3c designates a supervisory (evaluation) station.

The picture and sound signals 2 and 1, respectively, are preferably analyzed separately in the evaluation stations 3a and 3b. Afterwards, the results of both examinations are combined to form an overall result which leads to a decision as to whether or not an advertising block is present during the current reception. This combination is done on a supervisory station 3c coupled to the evaluation stations 3a and 3b and is based on a weighted assessment of N features presented above, whose presence or absence is designated by pᵢ (i=1 . . . N).

The parameters pᵢ assume values between 0 and 1. The value 0 is assigned if the associated feature has not been identified, and the value 1 is assigned if said feature has been identified with a predominant probability. Intermediate stages are also conceivable here, of course. Moreover individual features may be assigned a particular “active time”, a time period after the first occurrence of a feature within which the presence of the feature is still imagined to be existent, even though it is possibly no longer even present in the evaluation effected at the present time. Equally, proven fuzzy logic evaluation methods could be incorporated.

Preferably, each individual feature is also additionally allocated an individual weighting factor αᵢ which expresses its importance in relation to the other features and can also be altered afterward in the course of an optimized method configuration

The overall result WP—the probability of the instantaneous presence of an advertising block—can then be represented as follows on the basis of the presence or absence of the individual features:

WP=p₁*α₁+p₂*α₂+ . . . +p_{N}*α_{N}

The expression on the right-hand side can also be normalized, as required, to a suitable extent in order to adapt it for standard mathematical evaluation methods.

If, at a given point in time, the value of the evaluation result of WP lies above a predetermined threshold value, then the presence of an advertising block is identified and the transmission of the advertising block bit sequence with the advertising-block-is-running signal is initiated. If it lies below said threshold value, then this does not happen. The advertising block bit sequence with the advertising-block-is-not-running signal is then initiated.

Furthermore, if appropriate, logical boundary conditions are also incorporated in this evaluation, on the basis of which conditions the presence of an advertising block or the information sequence of an advertising commercial can be inferred indirectly, for instance. All the rules are preferably implemented in one or more programs which run on the computers of the evaluation system 6.

The sound and picture signals 1 and 2 are preferably evaluated in separate computer units 3a, 3b, for which respective backup units are kept ready for the fault situation. A degree of failure reliability can thereby be ensured.

Moreover, since the computational load with regard to the evaluation of a transmitter can, under certain circumstances, fluctuate very greatly with respect to time, an additional unit can be added if one unit is overloaded. This means that not only the evaluation of the two signal types can be parallelized but also the evaluation of the signals in each case themselves. In the case of picture identification, this can be done for example by separating the methods (identification of repetition sequences, identification of text, etc) Furthermore, a separation according to individual pictures would also be possible, however. Individual pictures are in this case distributed between a plurality of computer units. An analogous procedure can be performed in the case of sound signals.

In the case of the combination to form an overall result, mutually exclusive features are also considered in order thus to achieve a maximum identification reliability. In the supervisory station 3c, it is also possible to combine methods which have to be considered jointly. In this case, the supervisory station 3c, just like the units 3a, 3b connected upstream, is realized as an exchangeable module in order not to reduce the failure reliability.

Furthermore, the supervisory station 3c can also distribute computing power by allocating, as necessary, to a group of currently overloaded computers a possibly free computer capacity of another group of computers. In this respect, the computer groups must be networked together.

Further parallelization can be effected not only at the signal level but also at the transmitter level. The three units described in FIG. 1 can be installed per transmitter. This ensures that the failure or the overloading of one unit does not impair the function of the entire system. All the computer groups can then operate independently of one another, provided that they serve different transmitters, but are connected by the database system.

If a suitable operating system is used which ensures a high failure reliability in the case of simultaneously executed tasks, the computational load could also be distributed between the computers that are present in another way.

As described, this procedure has the aim of reducing the susceptibility to faults and overloading of the system and of increasing the failure reliability. The incorporation of the supervisory station 3c reduces the probability of an incorrect identification of an advertising block.

Usually, the advertising will probably not be identified by means of a single feature, rather a plurality of features will apply simultaneously. By adding new rules, it is possible to define new features and to set the system more perfectly over the course of time and adapt it to new requirements. It goes without saying that it is possible to employ only audio features for radio transmitters.

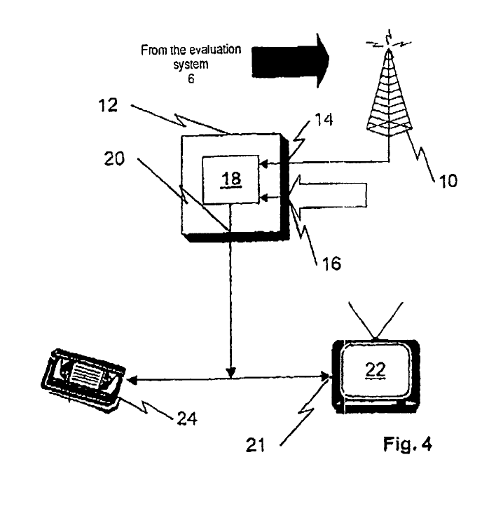

FIG. 4 shows a diagrammatic illustration of the mode of operation of the control box according to the invention in the context of the method according to the invention.

Reference symbol 10 designates a transmission device, reference symbol 12 designates the control box, reference symbols 14, 16 designate the inputs or receiving devices thereof, reference symbol 18 designates a processing logic unit, reference symbol 20 designates the output or transmission device thereof, reference symbol 21 designates an input of the television set, reference symbol 22 designates the television set and reference symbol 24 designates a video recorder.

The control box 12 can, in principle, communicate with apparatuses appertaining to consumer electronics from different apparatus classes. Therefore, in the identification of advertising and reaction, these must be considered in a differentiated manner since their use and the interfaces for communication differ. Appropriate apparatus classes at the present time are television receivers, video apparatuses and radios, but an application of the invention for further media that are yet to be realized is conceivable in an analogous manner.

The control box 12 has/contains the input 14 for receiving the advertising-block-is-running signal or the advertising-block-is-not-running signal as advertising block bit sequence, the input 16 for receiving an IR signal, the processing logic unit 18 for processing the advertising block bit sequence, and the IR output 20 in the form of an IR transmitter for driving the IR sensor 21 of the television set 22. The control box 12 reacts as a result of the reception of the advertising-block-is-running signal or the advertising-block-is-not-running signal or the changeover from the advertising-block-is-running signal state to the advertising-block-is-not-running signal state, or vice-versa.

In continuation of the method, as has been described above with reference to FIG. 1, a signal is transmitted to the television viewers by a transmission device 10, which lies within the access range of the service provider, in the context of a periodically transmitted advertising block bit sequence for each transmitter for which the service provider offers its service. Said signal indicates the instantaneous presence of an advertising block on the transmitter as advertising-block-is-running signal and the absence of said advertising block as advertising-block-is-not-running signal, which is distinctively configured differently from the former signal.

An appropriate signal would be, in the case of a digital, error-redundant transmission, as core content, by way of example, a bit sequence with customary header information, followed by a bit string, which provides a 1-bit flag per transmitter. The flag could jump from logic zero to logic one in order to show the start of the advertising block, then remain set during the advertising block, in order to indicate the presence of the advertising block, and jump back to logic zero when the end of the advertising block has been identified, and remain set as such as long as no new advertising block is identified.

This bit sequence is transmitted periodically, for example at a frequency of 10 Hz, and received by the control box 12 on the television viewer's premises and correspondingly processed further. Therefore, the presence or absence of the advertising block can be identified from a permanent evaluation of the signal and the start and the end of an advertising block can be identified from the transition in the changeover of the signals.

One possibility for transmitting the signal would be radio transmission. In this case, the signals are transmitted via radio waves from the transmitting station to the control box on the viewer's premises. Long wave transmitters similar to the DCF77 for the atomic clock signal are particularly suitable in this case. An advantage of this technology is the interference-free transmission which is possible even over very large distances. Only very small, inexpensive receivers with a very small antenna are required for this purpose. However, transmission via other frequencies, such as e.g. VHF, is also possible. In this case, it is possible to use existing services which transmit similarly to the RDS signal or similar additional signals.

A further service which is also available is the radio telephone network according to the GSM standard, via which services can be transmitted.

A further possibility is to transmit the advertising block bit sequence via unused lines in the television signal. This technology is already utilized by teletext and the VPS signal and is available immediately. In the transmission of the television signal, more lines are transmitted than are actually visible on the screen. The analog conversion of the advertising block bit sequence could then be coded into these lines, which is filtered out and interpreted by the control box 12. The advantage of immediate availability without excessive technical complexity is additionally accompanied here by a high transmission speed.

If radio transmission poses problems, the advertising-block-is-running signal and the advertising-block-is-not-running signal can be transmitted via the Internet or other online services. For this purpose, the signals are made available as in the case of a Real Audio player or in the case of Time Clients. The user can then log onto this service and periodically retrieve the advertising block bit sequence. The advertising-block-is-running signal and/or the advertising-block-is-not-running signal would then subsequently be made available to the control box 12 via the serial interface or a USB bus.

Technologies analogous to satellite television or satellite telephone can be utilized in the case of transmission via satellites. This would achieve a large global availability similar to that in the case of terrestrial transmitters. Via the satellite antenna, already existing resources can be utilized and the received information can be made available to the control box 12.

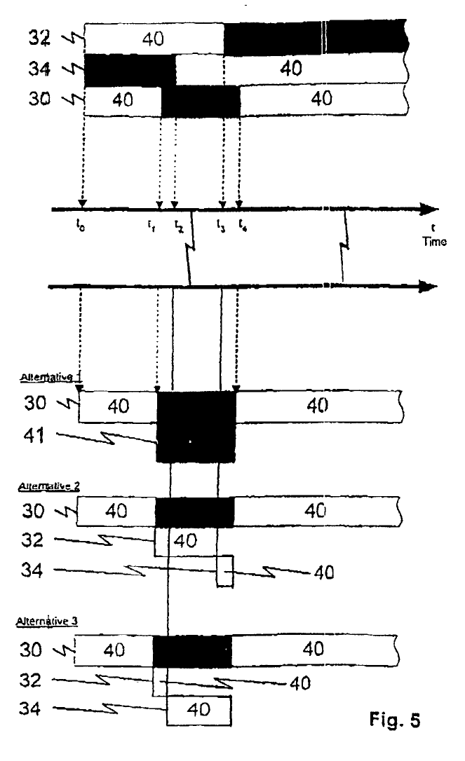

The functioning of the control box 12 is described in more detail below again with reference to FIG. 4 and with reference to FIG. 5.

In this case, FIG. 5 shows a more precise diagrammatic illustration of the mode of operation of the control box according to the invention in the context of the method according to the invention.

In FIG. 5, the reference symbols 30, 32 and 34 in each case designate transmission time slots of three different transmitters, the reference symbols 40 in each case designate blocks without advertising, the reference symbols 42 in each case designate blocks with advertising, hatched regions indicate the transmission time slots presented to the television viewer through measures of the control box 12.

The control box 12 may, as in the exemplary embodiment, also be programmable such that a popularity scale of transmitters can be programmed, according to whose rank order the transmitters are chosen, for the case where an advertising block is actually currently being transmitted on the ranking transmitter. This can be identified by evaluation of the cyclically updated and transmitted advertising block bit sequence before the choice of the new transmitter is made by the control box 12. In the present case, the transmitter 34 has a higher priority than the transmitter 32.

Let us assume that on the third transmitter, which is to be regarded as the deliberately set transmitter by the viewer and is represented as time bar 30 in FIG. 5, the control box 12 receives only advertising-block-is-not-running signals starting from the instant t₀ and registers the advertising-block-is-running signal at a given instant t1. This means that the service provider indicates the beginning of an advertising block and the control box 12, by means of the processing logic unit 18, transmits one of a selection of preselectable control signals, by means of the IR output 20, to the IR sensor as input 21 of the television set 22. The control signal causes the television set 22 to switch to a second operating state, which is different from the first initial state. In the present example, the second operating state of the television set is the reception operation of a different, preselected transmitter. The control box checks whether advertising is also possibly present in the highest-ranked “alternative transmitter” at the instant to, or shortly afterward, before it gives the control signal for switching to the transmitter 34. By evaluating the advertising block bit sequence, the control box establishes that advertising is also currently running in the transmitter 34. It then checks whether advertising is running in the next ranking transmitter, the transmitter 32. This is not the case. The consequence of this is that the control box switches to the transmitter 32 and the viewers see neither the advertising block of the third transmitter 30 nor that of the transmitter 34, but rather follow the first transmitter 32.

The advertising block bit sequence is monitored continuously, in principle. The control box 12 is programmed, then, in such a way that the alternative transmitter which was set first is intended to fill as completely as possible the suppression phase of the transmitter deliberately preset by the viewer, in as continuous a manner as possible. It therefore remains switched on when, at the instant t₂, the end of the advertising block has been identified on the transmitter 34, which is actually ranked higher.

At the instant t₃, an advertising block begins on the alternative transmitter 32. The alternative search strategy which has already been discussed above is then repeated. In the process, it is established that the transmitter 34 is not transmitting an advertising block. Therefore, the control box 12 then switches to the transmitter 34.

If the advertising block in the preselected transmitter 30 is then concluded at the instant t₄, this can be identified through a change in the corresponding bit flag at the position assigned to the transmitter 30 in the advertising block bit sequence and is correspondingly identified and evaluated by the control box. Therefore, a corresponding control signal is then again passed to the output 20 of the control box 12 and to the television set, which switches back again to the original transmitter 30. Consequently, the advertising block on transmitter 30 has been suppressed for the viewer and the associated period of time has elapsed without said viewer having had to watch advertising.

Three possible alternatives for the switching-over are specified at the bottom of FIG. 5. In this case, 41 designates a video recorder phase between t₁ and t₄.

In the suppression of advertising blocks, different modes of functioning of the control box are possible and also necessary, depending on which television set of the relevant apparatus class is connected to the control box.

In the case of a video recorder 24, (indicated diagrammatically in FIG. 3) which is connected to a television set or directly to the control box 12 and is intended to record a film transmitted together with advertising blocks, the recording would expediently have to be interrupted, whereas in the case of connected radios or television sets which the viewers use directly for listening to the radio or watching television, it would be possible e.g. to switch to a different transmitter or to turn the volume down.

Depending on the apparatus class, the control box 12 reacts differently to the beginning and end of advertising.

The communication paths between the control box and the television set are described in more detail below.

The communication from the television set 22 to the control box 12 is necessary in order that the transmitter currently set for reception at the television set is known to the control box. Furthermore, the control box must know the apparatus class to which the connected apparatus belongs, since the control measures effected by the control box on the apparatus differ depending on the apparatus class, and the viewer's desires.

Via the communication direction from the control box 12 to the connected apparatus, the control box informs the apparatus of how it is to react to the advertising. Thus, by way of example, a pause signal is communicated to video recorders, and, in the case of televisions, it is possible to switch to a different channel, or the picture can be switched to black and the sound lowered. Detailed further control measures for initiating the second operating state are described further below.

The communication can be effected via the video control signal. All new modern apparatuses provided with such a connection are controlled thereby. Via this port, the control box 12 can communicate with the television set 22, i.e. the television set thereby communicates which transmitter is presently set and its operating state. Equally, the control box 12 can now control the television set and transfer it to a different operating state.

Provided that the control box is installed in the transmission cone of the remote control associated with the television set, it can also receive which program the user has set. Equally, however, it can also transmit the signal for “switch off television” or “switch over” to the television set if advertising starts. In the exemplary embodiment, this control is effected directly from the control box 12 to the television set 22 via an infrared transmission link between the infrared output 20 of the control box and the infrared input 21 of the television set. Therefore, the control box 12 must be located in the transmission cone of the remote control and be directed with its IR input 16 toward the remote control and its IR, output 20 toward the television set 22. This is compatible with all apparatuses which are controlled by means of a remote control.

The communication can equally be effected via an emulated remote control. This option can be used in a highly universal manner for televisions and video apparatuses. In this case, the control box 12 emulates both the infrared receiver of the television and the infrared transmitter of the remote control. The technology used in this case is the same technology which is also used in programmable remote controls, and is thus available immediately.

Communication with old apparatuses which still use pushbutton switches for transmitter selection is likewise possible.

If the user has set the correct transmitter on the control box (e.g. via keypad or remote control), then it is possible, for example in the event of advertising occurring, for the television signal to be set to black and the sound to be turned down and the advertising thus to be suppressed. Thus, the technology of the control box can also be used for older apparatuses or those apparatuses which do not permit the newer technologies of IR communication.

A number of “second operating states” which might be obvious in the case of the respective apparatus class are also presented below.

For television reception, these include, inter alia, insertion of a preselected picture, switching to a different transmitter (e.g. news or music channel), insertion of additional information similar to teletext. In this case, the following would be worth a special mention: for example, stock market prices, the current weather report, news or traffic news, or switching to playback by a video recorder connected to the television set.

In the case of the direct control of a recording of a film on video recorders, the following are conceivable, inter alia: switching from recording to pause or the ending of the recording or the insertion of a predefined picture.

For radio reception, these include, inter alia, switching to a different transmitter (e.g. news or music channel), switching to CD or cassette playback or muting of the radio.

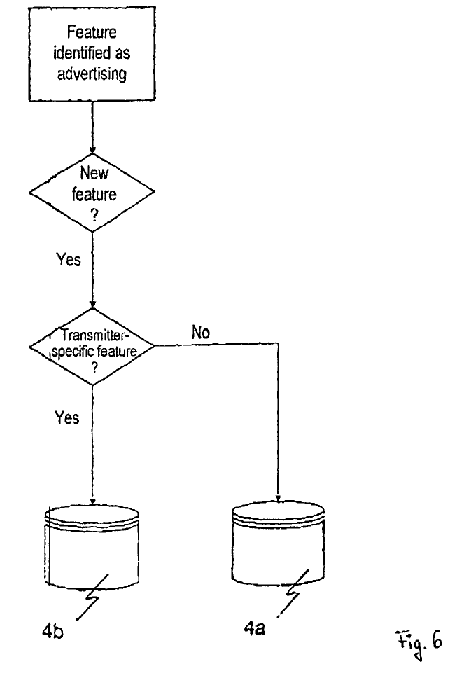

Advantageous developments of the method according to the invention are explained below with reference to FIG. 6 and again with reference to FIG. 2.

FIG. 6 shows a rough diagrammatic illustration of essential sequences of the method according to the invention which are required in the identification of the advertising block by the service provider, with a preferred supplementation which enables the learning of features.

Following on from the fact that in FIG. 1 advertising, i.e. features in the abovementioned sense, were identified, it is possible to accomplish a learning operation of the evaluation system 6 by updating the database 4a and, if appropriate, the database 4b, insofar as this appears beneficial. This is done, with special reference to FIG. 6, by the branch 50, which leads into a learning operation with regard to these features. For this purpose, the identified information sequences are differentiated according to “cross-transmitter” or “transmitter-specific” by the corresponding evaluation stations 3a and 3b and compared with the stock of information sequences contained in the databases 4a and 4b, respectively.

If an information sequence is identified as new advertising in a transmitter-specific manner, then it is stored, classified on the basis of its features, in the associated transmitter-specific database 4b. It is thus immediately available for reidentification.

More precisely, by interrogating all the databases 4a for all the transmitters, it is established whether the feature is already contained in one of these databases and is thus transmitter-specific. If it is not found, then it is entered into the database 4b of the transmitter on which it was received. If it is found in a database 4b of another transmitter, then the feature is stored in the database 4a for cross-transmitter features. In this way, the evaluation system “learns” the features “by heart”.

This affords the advantages that information sequences no longer have to be examined for their entire contents, rather a simple comparison with the contents of the databases suffices. This accelerates the search by simplifying the adjustment operation, since advertising which has been identified on one channel is also immediately identified as such for the other channels. Moreover, the databases are thus always up-to-date.

By virtue of these measures, the probability of identifying advertising continually increases since the system independently identifies new advertising. If one feature fails, it can seamlessly be replaced by others. Each of the indicators increases the probability of identification.

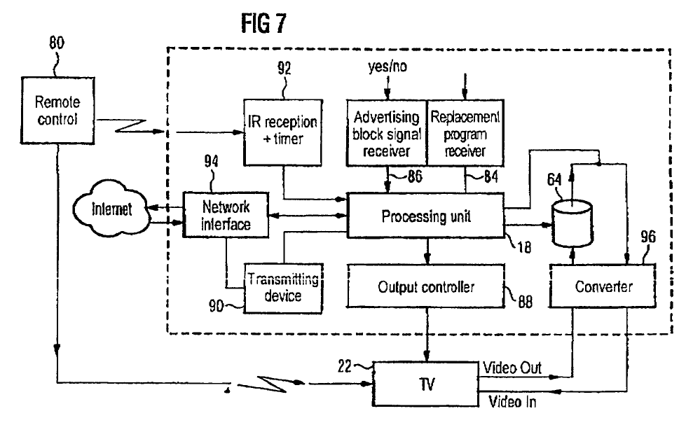

FIG. 7 shows a diagrammatic illustration of a block diagram of the control box in a further preferred embodiment.

In FIG. 7, reference symbol 12 shows the control box, reference symbol 20 shows a control output, reference symbol 22 shows the television set, reference symbol 80 shows the remote control, reference symbol 82 shows a receiving device, reference symbols 84 and 86 show connecting lines, reference symbol 90 shows a transmitting device, reference symbol 92 shows a timer, reference symbol 94 shows a network interface, and reference symbol 96 shows a converter.

Referring particularly to FIG. 7, this embodiment of the control box will now be described below in the case of interaction with a television set.

The block diagram of FIG. 7 reveals the three main components of the arrangement, namely the control box 12, whose individual components are surrounded by a dashed line, the television set 22 and the remote control 80 for driving the control box 12 and the television set 22.

A receiving device 82 is connected to the processing unit 18 via two connecting lines 84 and 86. Via the line 86, the abovementioned advertising-block-is-running signal and also the advertising-block-is-not-running signal are passed into the processing unit. Via the line 84, signals can be input into the processing unit 18 which are intended to offer the television viewer a replacement program precisely when an undesired advertising block is running.

The processing unit is connected by its main output 22 to the connection unit for the television set. The replacement program is fed into the television set via said connection unit.

In accordance with this particularly preferred aspect of the present invention, the control box 12 is also additionally provided with a transmitting device 90. The latter serves for transmitting data to the service provider which contain statements about the consumer behavior of the television viewer, and which can later be evaluated by the service provider. It is a matter of great interest to the television viewer that he receives films which interest him for watching on television. These may, of course, also be explicitly particular advertising commercials. The service provider should be helpful in the selection of the suitable replacement program for this. For this purpose, coding of all transmissions on all channels is provided, which is carried out by the service provider. The individual codes may, for example, denote nature films, films concerning technological matters, crime films, political information broadcasts, economic information broadcasts, etc. Equally, it is possible to code advertising commercials according to particular interest groups and target audience, such as, for example, housewife, family, so-called high earners, sports enthusiasts, etc.

In order to be able to detect the preferences of a person assigned to a particular control box, the respectively received channel number, for example that of ARD, ZDF, SAT1, etc, and also the beginning and the end of that time slot which is currently being received by the viewer on this channel are expediently captured via the actuation of the normal remote control 80 for the television set 22. The date, too, can preferably be detected as well. For this purpose, the infrared interface of a timer 92 appropriate for the remote control 80 receives practically all the actuation actions of the television viewer, provides said actions with a timestamp and forwards this information via a connecting line to the processing unit 18, where it can be conditioned, if appropriate, in terms of data technology by means of a microprocessor and passed on to the transmitting device 90, for example periodically for the purpose of transmission to the service provider. For this purpose, the transmitting device 90 is preferably connected to a network interface 94 having, for example, a connection to the Internet or to a telephone network, radio network or fixed network. Consequently, the data can be sent in digitized form to the service provider, which must likewise have a corresponding interface, for the purpose of evaluation. The service provider receives the data packets, which, as mentioned above, contain at least the channel number, beginning and end of a particular received program section and also the date, and can then adjust this information with the abovementioned codes, as a result of which said service provider is informed of the viewers television habits.

After evaluation by the service provider, replacement programs can then be transmitted for the viewer, which replacement programs are selected by the service provider in an automated manner, if appropriate, and can be assumed to coincide better, from a statistical standpoint, with the main points of interest of the viewer than the conventional, relatively arbitrarily compiled sequence of advertising commercials.

Moreover, the control box 12 is additionally provided with a buffer memory 64, which serves as a time buffer for the recording of picture and/or sound sequences of a video sequence which the viewer cannot actually watch at present since this is not convenient for some reason, for example a toilet break or because a replacement program lasts somewhat longer than the advertising block of the original film originally being watched by the viewer.

For this purpose, the buffer memory 64 is connected to the processing unit 18 for the purpose of control by the latter, which processing unit, for its part, has a bidirectional connection to the network interface in particular for the purpose of receiving data and sound and picture sequences. Furthermore, there is a connection to a bidirectional converter 96, which converts the analog picture and sound signals into digital signals which are provided for storage in the buffer memory 64. The converter may contain customary devices for data compression and data decompression. The converter 96 is then connected to the video OUT and video IN connections of the television set, with a control box configured in this way, not only can the buffer memory 64 show the current program in a temporally staggered manner, but it is also possible “to make up” a delay through the identification of advertising blocks in order to be able to watch the original film again without a temporal offset at any later point in time. Particular importance may be attached to this property in particular in the case of live transmissions of sporting events. Furthermore, the buffer memory 64 means that complete films can be watched in a time-delayed manner if an advertising block which is not desired by the viewer is exchanged for example for an alternative advertising block which is selected by the service provider and happens to be somewhat longer.

Furthermore, it is possible to download video sequences from the Internet with a low data transfer rate and then watch them at normal reproduction speed at a later point in time.

The capability of the control box to enable particular data, which usually have only a small scope, to be transmitted to a service provider can advantageously be used for opinion poles or in prize games. For this purpose, the service provider may, for example, insert a button at a particular point in the television picture, which button indicates to the television viewer the selection options available to him in the case of such an interaction.

Furthermore, it is possible to build up a bonus system in which a television viewer receives a certain number of bonus points for watching particular advertising commercials. By reporting back the bonus points to the client of an advertising commercial, previously existing advertising strategies can be effectively improved.

Since the control box is provided with an interface to the Internet, the television viewer can, if interested, also simultaneously surf the Internet during an advertising block.

Although the present invention has been described above using a preferred exemplary embodiment, it is not restricted thereto, but rather can be modified in diverse ways.

In particular, the configuration of the evaluation system 6 of the service provider can be configured differently. All that is essential is that the comparisons of the received signal sequences with stored sequences and/or stored features or events be carried out.

Furthermore, it is possible to configure the transmission of the signal which distinguishes between advertising and non-advertising via any desired transmission links, inter alia also as an analog signal.

In particular, the control box can be installed in new apparatuses or be retrofitted in old apparatuses or be provided externally. In principle, the control box could also be integrated in the remote control or a computer.

Furthermore, it is evident that the arrangement of the individual components of the control box 12 as shown in FIG. 7 can also be combined to form larger structural units, if this appears expedient. Moreover, only those functional features which are crucial for the functional principle of the present invention are represented by components or structural units in FIG. 7.

The inventive concept can also be used in such a way that it functions in each case individually for particular sub-areas of the screen. By way of example, given a television monitor of appropriate size, a particular corner of the screen can show more or less permanently the original film without a temporal offset, while the main area shows the above-described temporally staggered sequence of the film. If necessary, the small window can also be made large and the large window can be made correspondingly small.

In principle, if different alternatives are given by a selection to be made by the television viewer, said different alternatives can be represented on-screen in particular excerpts on the screen, in order to facilitate the selection.

Furthermore, the above statements also apply to excerpts from transmissions.

The network interface 94 is connected to the processing unit 18. Via this connection, data can be taken from the Internet in order to be viewed on the screen either immediately or after buffer-storage in the buffer memory 64 and by conditioning by the converter 96. This property can also advantageously be used for the storage and/or reproduction of the abovementioned replacement program, by the replacement program, such as e.g. alternative advertising commercials or film sequences generally being conducted from the service provider by means of suitable transmission technologies such as, for instance, “data streaming” or related technologies via the Internet or other network connections into the memory when the television viewer does not require the memory, for instance because he is watching television “live” in a conventional manner.

With regard to the buffering, it shall also be mentioned that all transmissions can generally be buffered and reproduced in a temporally staggered manner (e.g. a few seconds). if the identification is not carried out in real time (1/25 s), no cutting pauses are produced.

Since the approximate duration of the advertising blocks is known, it is possible to provide an insert in advance in order that the program can be watched in one piece, and the end comes just in time.

Moreover, it is possible for the advertising not to be suppressed but only reported, e.g. by transmission to media services.

| | |
|---|---|
| 1 | Sound signal |
| 2 | Picture signal |
| 3a | Evaluation station for sound signal |
| 3b | Evaluation station for picture signal |
| 3c | Supervisory station |
| 4a | Database for cross-transmitter features |
| 4b | Database for transmitter-specific features |
| 4c | Database for film repetition features |
| 6 | Evaluation system (3a-4c) |
| 10 | Transmission device |
| 12 | Control box |
| 14 | Input for advertising block bit sequence |
| 16 | IR input |
| 18 | Processing logic unit |
| 20 | IR output |
| 21 | IR input of the television set |
| 22 | Television set |
| 24 | Video recorder |
| 30 | Third, deliberately set transmitter |
| 32 | First transmitter |
| 34 | Second transmitter |
| 40 | Transmission time slot without advertising |
| 41 | Video recorder phase |
| 42 | Transmission time slot with advertising |
| 64 | Buffer memory |
| 66-74 | Instants |
| 80 | Remote control |
| 82 | Receiving device |
| 84, 86 | Connecting lines |
| 90 | Transmitting device |
| 92 | Timer |
| 94 | Network interface |
| 96 | Converter |

1. A method for suppressing the recording and/or reproduction of undesirable program sections, in particular advertising, transmitted by a transmitter, for an apparatus (22) pertaining to consumer electronics, having the following steps:
definition of the undesirable program sections, which can be identified by a coded identification signal which can be received from an online service provider, in particular an Internet service provider, by means of an input device;
identification of the start of an undesirable program section, in particular an advertising block, and provision of the identification signal by an identification device (6) set up for communication with the apparatus (22) appertaining to consumer electronics, said apparatus being in a first operating state;
transmission of a corresponding first signal to a control box (12) which can be connected to the apparatus (22) appertaining to consumer electronics;
processing of the first signal in the control box (12);
changeover of the apparatus (22) into a second operating state by means of a measure effected by the control box (12) in response to the first signal;
identification of the end of the undesirable program section, in particular the advertising block, by the identification device (6), transmission of a corresponding second signal to the control box (12);
processing of the second signal in the control box (12);
changeover of the apparatus (22) back into the first or a third operating state by means of a measure effected by the control box (12) in response to the second signal;
insertion of a replacement program at least during the validity of the first signal on the apparatus (22) appertaining to consumer electronics.

2. The method as claimed in claim 1, which has the following steps:
transmission of information with regard to the consumer behavior of the user of the apparatus (22) via a network interface (94) to the online service provider.

3. The method as claimed in claim 2, which has the following steps:
evaluation of the information with regard to the consumer behavior of the user of the apparatus (22) at the online service provider; and
selection of the replacement program in accordance with the evaluation and transmission of the replacement program to the apparatus (22) by the online service provider.

4. The method as claimed in claim 1, 2 or 3, which has the following steps:
buffering of the replacement program and/or of the current program, interrupted by the reception of the first signal, in a buffer memory (64); and
temporally staggered reproduction of the buffered replacement program and/or of the current program interrupted by the reception of the first signal.

5. The method as claimed in one of the preceding claims, wherein the apparatus (22) is a television and the information of the television signal is stored separately according to sound sequence and picture sequence and is evaluated in each case individually, preferably in parallel, according to different predetermined criteria for advertising block identification by the identification device (6).

6. The method as claimed in one of the preceding claims in application during a simultaneous recording of a transmission onto the medium of a recording device, wherein it contains the step of stopping the recording during the transmission time of an undesirable program section and resuming it after the end of said undesirable program section.

7. A control box for carrying out the method as claimed in claim 1, having:
an input device for defining undesirable program sections;
a receiving device (82, 84, 86) for receiving the first and second signals made available by the identification device (6), preferably in the form of an external service provider, and for receiving the replacement program;
a signal processing unit (18) for processing the received first and second signals;
an output device (20) for controlling the apparatus (22) appertaining to consumer electronics;
a transmitting device (90) for transmitting the information with regard to the consumer behavior, preferably information about the duration and/or the reception channel of program sections received most recently by the apparatus (22) appertaining to consumer electronics; in which case the transmitting device (90) can be coupled to the network interface (94) in order to transfer the data.

8. The control box as claimed in claim 7, wherein it can be connected to a buffer memory (64) which is set up for buffer-storing information with regard to sections of the currently received transmission or information from the network interface (94) and for outputting it again to the apparatus (22) appertaining to consumer electronics.

9. The control box as claimed in claim 7 or 8, wherein it has a further receiving device (16), with which it is set up for receiving a signal originating from a remote control of the apparatus (22) appertaining to consumer electronics.

10. The control box as claimed in claim 9, wherein the processing device (18) is set up for processing the signal of the remote control for the purpose of selection of the second operating state of the apparatus (22).
